(19) United States
(12) Patent Application Publication
(10) Pub. No.: US 2015/0306930 A1
(43) Pub. Date: Oct. 29, 2015

(54) SAFETY CHAIN FOR TOWED VEHICLES

(71) Applicant: Power Pin Inc., Fort Qu'Appelle (CA)

(72) Inventor: Brian R. Olson, Fort Qu'Appelle (CA)

(21) Appl. No.: 14/590,436

(22) Filed: Jan. 6, 2015

(30) Foreign Application Priority Data
Apr. 23, 2014 (CA) 2849657

(51) Int. Cl. B60D 1/28

(52) U.S. Cl. CPC B60D 1/28

(57) ABSTRACT

A safety chain apparatus for connecting a trailer to a towing vehicle includes a chain, comprising a continuous length of chain links, extending through a right and left tongue holes defined in a right and left side portions of the trailer tongue. An engagement device is installed on right and left ends of the chain, the engagement devices adapted to be attached to corresponding attachment locations of the towing vehicle. Right and left blocking members are each secured to a selected blocking chain link between the right and left tongue holes and configured to prevent passage of the selected blocking chain links through the corresponding right and left tongue holes.

This disclosure relates to the field of hitches for connecting a towed vehicle to a towing vehicle and in particular a safety chain for such hitch connections.

### BACKGROUND

Connecting mechanisms for trailers and like towed vehicles take a variety of forms, such as clevis and tongue mechanisms, ball and socket mechanisms, pintle hook and ring mechanisms, and the like. For on road use, most jurisdictions require that a safety chain, cable, or like tether be connected between the vehicles as well to keep the vehicles connected if the hitch apparatus fails.

Trailer safety tethers are described in U.S. Pat. No. 6,179,317 to Hurst, et al. and U.S. Pat. No. 6,279,939 Austin. The most common tether used is a chain, and this specification uses the word “chain” to include cables and like other means that could be used in place of the chain as is known in the art. Typically there are right and left safety chains attached at rear ends thereof to the trailer on corresponding right and left sides of the trailer hitch member, and the front end of each chain comprises a hook or the like adapted to attach to the towing vehicle. The two separate chains provide redundancy in case one chain fails.

A problem with safety chains is that the location of the attachment points for the chains on the towing vehicle vary with the different towing vehicles used. The distance from the point where the trailer hitch member engages the hitch member of the towing vehicle can vary considerably from one towing vehicle to another. Thus the chains in some cases can be too short to reach the attachment location on the towing vehicle. To avoid that scenario where the safety chains are too short and the trailer connection cannot be made at all, it is common to make the chains quite long, such that in many cases once attached the chains droop and drag on the ground. This contact with the ground causes the links to wear and weaken the chain.

U.S. Pat. No. 5,918,896 to Jenkins, Jr. addresses the problem by providing a plate for attachment to the towing vehicle with apertures that engage the links of the chain. The engaged links can be chosen to adjust the effective length of chain between the towing vehicle and the trailer so that the chains do not drag on the ground.

U.S. Pat. No. 7,963,543 to Green discloses safety chain adjusting boxes with slots that engage each chain at a selected link to adjust the effective length of the chain.

### SUMMARY OF THE INVENTION

The present disclosure provides a safety chain apparatus for towed vehicles that overcomes problems in the prior art.

In a first embodiment the present disclosure provides a safety chain apparatus for connecting a trailer to a towing vehicle. The apparatus comprises a trailer with a trailer tongue extending forward from a frame of the trailer, and a hitch member attached to a front end of the trailer tongue and adapted to connect to the towing vehicle. A chain, comprising a continuous length of chain links, extends through a right tongue hole defined in a right side portion of the trailer tongue and through a left tongue hole defined in a left side portion of the trailer tongue. An engagement device is installed on right and left ends of the chain, the engagement devices adapted to be attached to corresponding attachment locations of the towing vehicle. Right and left blocking members are each secured to a selected blocking chain link between the right and left tongue holes and configured to prevent passage of the selected blocking chain links through the corresponding right and left tongue holes.

In a second embodiment the present disclosure provides a method of connecting a safety chain between a trailer and a towing vehicle, the trailer comprising a trailer tongue extending forward from a frame of the trailer, and a hitch member attached to a front end of the trailer tongue and connected to the towing vehicle. The method comprises providing a chain comprising a continuous length of chain links and extending the chain through a right tongue hole defined in a right side portion of the trailer tongue and through a left tongue hole defined in a left side portion of the trailer tongue; attaching an engagement device on right and left ends of the chain; selecting right and left blocking chain links, each blocking chain link located between the right and left tongue holes, and preventing passage of the selected right and left blocking chain links through the corresponding right and left tongue holes; attaching the engagement devices to corresponding attachment locations on the towing vehicle.

The safety chain apparatus of the present disclosure reduces the cost of providing a safety chain. A single continuous chain is used so that instead of fastening two separate chains to the trailer, the single chain can simply be threaded through holes in the trailer frame and then the hooks are fastened on each end, or the hook on one end can be attached any time before if desired. The blocking members are economical and easily installed and the blocking chain links can be selected to provide a desired effective length between the hooks and blocking members that can be quite long to accommodate attachment locations on a variety of towing vehicles, and a bias element can be provided that will take up any slack and prevent the chains from dragging on the ground.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the safety chain apparatus of the present disclosure connecting a trailer to a towing vehicle;

FIG. 2 is a schematic top view of the embodiment of FIG. 1;

FIG. 3 is a schematic side view of the embodiment of FIG. 1;

FIG. 4 is a schematic side view of an alternate blocking member provided by a chain link connector.

### DETAILED DESCRIPTION OF THE ILLUSTRATED EMBODIMENTS

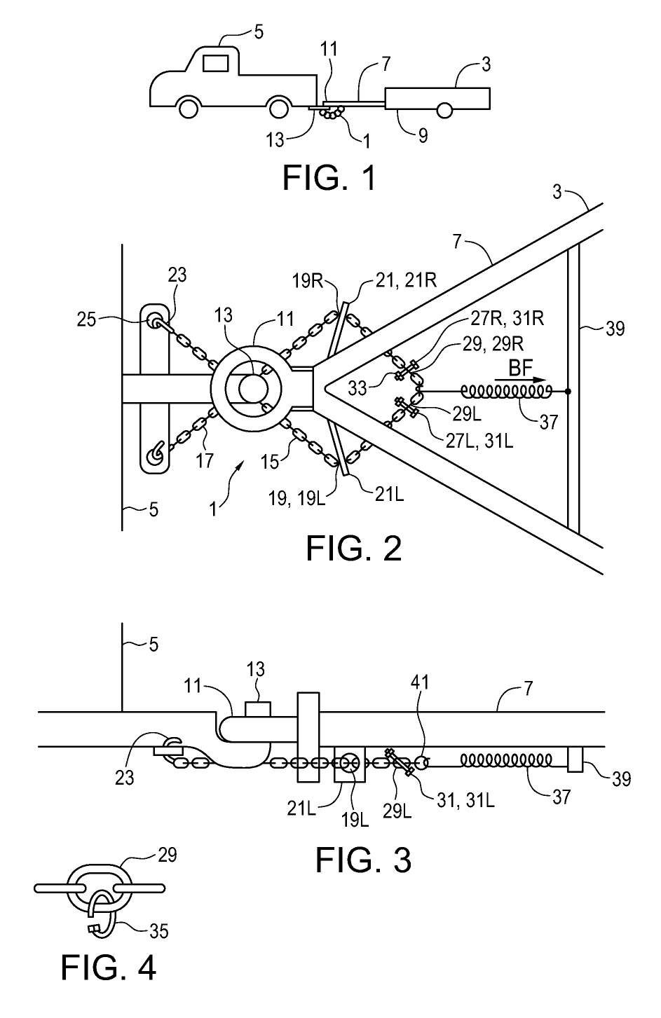

FIGS. 1-3 schematically illustrate an embodiment of a safety chain apparatus 1 of the present disclosure for connecting a trailer 3 to a towing vehicle 5. The apparatus 1 comprises a trailer 3 with a trailer tongue 7 extending forward from a frame 9 of the trailer 3, and a hitch member 11 attached to a front end of the trailer tongue 7 and adapted to connect to a tow hitch 13 of the towing vehicle 5. The hitch member 11 and tow hitch 13 are illustrated as a ring and pintle hitch arrangement but could also be a ball and socket or other hitch arrangement as known in the art. A lock arrangement as is known in the art will typically prevent the hitch member 11 from disengaging from the tow hitch 13.

A chain 15 comprising a continuous length of chain links 17 extends through a right tongue hole 19R defined in a right side portion of the trailer tongue 7 and through a left tongue hole 19L defined in a left side portion of the trailer tongue 7. In the illustrated apparatus 1 the right side portion of the trailer tongue 7 that defines the right tongue hole 19R comprises a right plate 21R extending laterally outward rearward of, and in proximity to, the hitch member 11. Similarly, the left side portion of the trailer tongue 7 that defines the left tongue hole 19L comprises a left plate 21L extending laterally outward rearward of, and in proximity to, the hitch member 11 opposite the right plate 21R.

Engagement devices on right and left ends of the chain 15, illustrated as hooks 23, attach to corresponding attachment locations 25 of the towing vehicle 5. Right and left blocking members 27R, 27L are each secured to a selected blocking chain link 29 between the right and left tongue holes 19R, 19L. The blocking members 27 are configured to prevent passage of the selected blocking chain links 29 through the corresponding tongue holes 19.

The illustrated blocking members 27 are provided by right and left bolts 31R, 31L extending through corresponding right and left blocking chain links 29R, 29L and fastened with nuts 33 which will typically be lock nuts. The bolts 31 are sufficiently long to prevent movement of the blocking chain links 29 through the tongue holes 19. Alternatively the blocking members 27 can provided by a chain link connector 35 as schematically illustrated in FIG. 4, or by any similar device that can be fixed to the blocking chain links 29 and prevent the blocking chain links 29 from passing through the tongue holes 19. In the illustrated apparatus 1 the right and left blocking chain links 29R, 29L are selected such that a distance from the right blocking member 29R to the right end of the chain 15 is substantially equal to a distance from the left blocking member 29L to the left end of the chain 15.

Thus when the blocking members 27 are secured to the blocking chain links 29, the single continuous length of chain links 17 making up the chain 15 effectively provides two separate safety chains as typically required by safety regulations. If the hitch member 11 disengages from the tow hitch 13, the right safety chain, extending between the hook 23 on the right end of the chain 15 and the right blocking member 27R bearing against the right plate 21R, pulls tight, and similarly the left safety chain, extending between the hook 23 on the left end of the chain 15 and the left blocking member 27L bearing against the left plate 21L, pulls tight. Because the blocking chain links 29R, 29L are equidistant from the corresponding hooks 23, the right and left safety chains are the same length and tend to hold the trailer centered behind the towing vehicle 5.

A bias element 37 is attached to the chain 15 between the right and left tongue holes 19R, 19L and to the trailer 3 at a frame member 39 rearward of the tongue holes 19. The bias element 37 could be provided by an elastic strap, spring, or the like with hooks on each end for convenient connection, and is operative to exert a rearward bias force BF on the chain 15. In the illustrated apparatus 1 the bias element 37 is attached to a selected bias chain link 41 located between the right and left blocking members 27R, 27L. The bias element 37 draws the middle of the chain 15 rearward and pulls the blocking members 27 away from the corresponding right and left plates 21 and prevents the chain from dragging on the ground.

The present disclosure also provides a method of connecting a safety chain 15 between a trailer 3 and a towing vehicle 5. The method comprises providing a chain 15 comprising a continuous length of chain links 17 and extending the chain 15 through a right tongue hole 19R defined in a right side portion, illustrated as right plate 21R, of the trailer tongue 7 and through a left tongue hole 19L defined in a left side portion, illustrated as left plate 21L of the trailer tongue 7; attaching an engagement device, illustrated as hook 23, on right and left ends of the chain 15, where the hook can be attached to one end of the chain prior to inserting the chain through the tongue holes 19; selecting right and left blocking chain links 29R, 29L, each blocking chain link 29 located between the right and left tongue holes 19R, 19L, and preventing passage of the selected right and left blocking chain links 29R, 29L through the corresponding right and left tongue holes 19R, 19L; and attaching the engagement devices to corresponding attachment locations on the towing vehicle. Conveniently the blocking members 27 can be provided by bolts 31, chain link connectors 35, or like devices which can attach to the blocking chain link 29 and make same too large to fit through a tongue hole 19.

It is contemplated that the tongue holes 19 could also include a slot into which a chain link is placed and prevented from moving out of the slot. Other methods for preventing passage of the blocking chain links 29 through the corresponding tongue holes 19 are contemplated as well.

The safety chain apparatus 1 of the present disclosure reduces the cost of providing a safety chain as a single continuous chain 15 is used. Instead of fastening two separate chains to the trailer, the single chain 15 can simply be inserted through holes in the trailer frame and then the hooks 23 are fastened on each end, or the hook on one end can be attached any time before if desired. The blocking members 27 are economical and easily installed and the blocking chain links 29 can be selected to provide a desired effective length between the hooks 23 and blocking members 27. The effective length can be quite long to accommodate attachment locations 25 on various towing vehicles, as the bias element will take up any slack and prevent the chains from dragging on the ground.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A safety chain apparatus for connecting a trailer to a towing vehicle, the apparatus comprising:
a trailer with a trailer tongue extending forward from a frame of the trailer, and a hitch member attached to a front end of the trailer tongue and adapted to connect to the towing vehicle;
a chain comprising a continuous length of chain links, the chain extending through a right tongue hole defined in a right side portion of the trailer tongue and through a left tongue hole defined in a left side portion of the trailer tongue;
an engagement device on right and left ends of the chain, the engagement devices adapted to be attached to corresponding attachment locations of the towing vehicle;
right and left blocking members, each blocking member secured to a selected blocking chain link between the right and left tongue holes and configured to prevent passage of the selected blocking chain links through the corresponding right and left tongue holes.

2. The apparatus of claim 1 wherein the blocking members are provided by right and left bolts extending through corresponding right and left blocking chain links and fastened with nuts.

3. The apparatus of claim 1 wherein the blocking members are provided by chain link connectors.

4. The apparatus of claim 1 wherein the right and left blocking chain links are selected such that a distance from the right blocking member to the right end of the chain is substantially equal to a distance from the left blocking member to the left end of the chain.

5. The apparatus of claim 1 comprising a bias element attached to the chain between the right and left tongue holes and to the trailer rearward of the tongue holes and operative to exert a rearward bias force on the chain.

6. The apparatus of claim 1 wherein the bias element is attached to a selected bias chain link located between the right and left blocking members.

7. The apparatus of claim 5 wherein the bias element is provided by one of an elastic strap and a spring.

8. The apparatus of claim 1 wherein the right side portion of the trailer tongue defining the right tongue hole comprises a right plate extending laterally outward rearward of, and in proximity to, the hitch member.

9. The apparatus of claim 8 wherein the left side portion of the trailer tongue defining the left tongue hole comprises a left plate extending laterally outward rearward of, and in proximity to, the hitch member.

10. The apparatus of claim 1 wherein the engagement devices are provided by hooks.

11. A method of connecting a safety chain between a trailer and a towing vehicle, the trailer comprising a trailer tongue extending forward from a frame of the trailer, and a hitch member attached to a front end of the trailer tongue and connected to the towing vehicle, method comprising:
providing a chain comprising a continuous length of chain links and extending the chain through a right tongue hole defined in a right side portion of the trailer tongue and through a left tongue hole defined in a left side portion of the trailer tongue;
attaching an engagement device on right and left ends of the chain;
selecting right and left blocking chain links, each blocking chain link located between the right and left tongue holes, and preventing passage of the selected right and left blocking chain links through the corresponding right and left tongue holes;
attaching the engagement devices to corresponding attachment locations on the towing vehicle.

12. The method of claim 11 comprising preventing passage of the selected right and left blocking chain links through the corresponding right and left tongue holes by fastening right and left blocking members to the right and left blocking chain links.

13. The method of claim 12 wherein the blocking members are provided by bolts inserted through the blocking chain links and fastened the bolts with nuts.

14. The method of claim 12 wherein the blocking members are provided by chain link connectors.

15. The method of claim 11 comprising exerting a rearward bias force on the chain at a location between the right and left tongue holes.
